(19) United States
(12) Patent Application Publication
(10) Pub. No.: US 2009/0044792 A1
(43) Pub. Date: Feb. 19, 2009

(54) Barometric Pressure Regulator Circuit

(75) Inventor: Patrick Hogue, Renton, WA (US)

Correspondence Address: FISH & RICHARDSON, PC, P.O. BOX 1022, MINNEAPOLIS, MN, 55440-1022, US

(73) Assignee: PLASMADRIVE, INC., Burlington, WA (US)

(21) Appl. No.: 12/192,004

(22) Filed: Aug. 14, 2008

Related U.S. Application Data
(60) Provisional application No. 60/955,833, filed on Aug. 14, 2007.

(51) Int. Cl. F02D 41/00

(52) U.S. Cl. 123/676

(57) ABSTRACT

A barometric pressure regulator circuit is described. The circuit includes a memory storing output parameters to be supplied to a pressure regulator unit, and a processor operatively coupled to the memory. The processor is configured to perform operations including receiving voltage signals representing output parameters of an engine, storing the received voltage signals in the memory, identifying output parameters to be supplied to the pressure regulator unit that correspond to the received voltage signals, converting the identified output parameters into output electrical signals, and transmitting the output electrical signals to the pressure regulator unit.

### CROSS-REFERENCE TO RELATED APPLICATIONS

This application claims priority to U.S. Patent Application No. 60/955,833, entitled Barometric Pressure Regulator Circuit, to inventor Patrick Hogue, which was filed on Aug. 14, 2007. The specification of the above application is incorporated herein by reference in its entirety.

### TECHNICAL FIELD

This specification relates to regulating pressure, for example, pressure in engines.

### BACKGROUND

Engines, e.g., automobiles and other industrial equipment, can use a combustible fuel to supply energy to a vehicle. Waste from the fuel can be expelled as exhaust gases via exhaust systems coupled to the engines. To increase the air flow, and thereby reduce pressure, pressure regulators can be operatively coupled to the exhaust systems. Input parameters to the pressure regulators can depend upon output parameters of the engine.

### SUMMARY

This specification describes technologies relating to barometric pressure regulator circuits. In one example, an internal combustion engine is operatively coupled to a pump that is configured to regulate flow through the exhaust system of the internal combustion engine to regulate the pressure in the exhaust system. The engine and the pump can be operatively coupled to a barometric pressure regulator circuit. The circuit can receive electrical signals from the internal combustion engine as input. The received electrical signals can represent operating parameters of the engine. Based on the received input, the circuit can determine output parameters to operate the pump such that the performance of the engine is optimized. The circuit can provide electrical signals representing the output parameters to the pump. In turn, the pump can regulate flow through the exhaust system, thereby regulating pressure in the system.

In one aspect, a system includes an engine and an engine monitoring unit operatively coupled to the engine. The engine monitoring unit is configured to receive signals representing output parameters of the engine. The system includes a pressure regulator circuit operatively coupled to the engine monitoring unit. The pressure regulator circuit is configured to receive one or more of the signals representing the output parameters of the engine from the engine monitoring unit. The pressure regulator circuit is further configured to determine output parameters to control a pressure in the engine. The system includes a pressure regulator unit operatively coupled to the pressure regulator circuit. The pressure regulator unit is configured to receive the output parameters to control the pressure in the engine. The pressure regulator unit is operatively coupled to the engine to control an engine pressure. The pressure regulator unit controls the engine pressure based on the output parameters determined by the pressure regulator circuit.

This, and other aspects, can include one or more of the following features. The engine can be an internal combustion engine. The pressure regulator unit can be a pump. The received signals representing output parameters of the engine are electrical signals. The system can further include one or more electrical wires connecting the engine and the engine monitoring unit. The one or more wires can be configured to transmit the electrical signals. One or more signals received by the pressure regulator circuit can be electrical signals having corresponding voltages. The pressure regulator circuit can further include a memory configured to store the voltages corresponding to the one or more signals. The memory can be configured to store the voltages as binary numbers. The pressure regulator circuit can further include a processor configured to retrieve the one or more voltages from the memory, determine values representing the output parameters to control the pressure in the engine, and transmit the determined values to the pressure regulator unit as electrical signals. The system can further include multiple sensors operatively coupled to the engine to determine the output parameters of the engine. The multiple sensors include a piezoelectric pressure sensor, a barometric pressure sensor, a thermocouple, and an RPM sensor.

In another aspect, a pressure regulator circuit includes a memory storing output parameters to be supplied to a pressure regulator unit, and a processor operatively coupled to the memory. The process is configured to perform operations including receiving voltage signals representing output parameters of an engine, storing the received voltage signals in the memory, identifying output parameters to be supplied to the pressure regulator unit that correspond to the received voltage signals, converting the identified output parameters into output electrical signals, and transmitting the output electrical signals to the pressure regulator unit.

This, and other aspects, can include one or more of the following features. The pressure regulator unit can be a pump. The engine can be an internal combustion engine. The processor can receive the voltage signals through one or more electrical wires. The processor can transmit the output voltage signals to the pressure regulator unit through a wiring harness including multiple wires. The memory can store preset parameters including the output parameters to be supplied to the pressure regulator unit and preset values corresponding to the output parameters. The process can further be configured to identify the output parameters to be supplied to the pressure regulator unit by identifying the preset values that match values of the voltage signals that represent output parameters of the engine, and identifying the output parameters corresponding to the identified preset values.

Particular implementations of the subject matter described in this specification can be implemented to realize one or more of the following advantages. Significant improvements in the engines miles-per-gallon (MPG) fuel efficiency can be obtained. In addition, improvements in engine horse power, maximum speed, and low-end torque can also be obtained.

The details of one or more implementations of the specification are set forth in the accompanying drawings and the description below. Other features, aspects, and advantages of the specification will become apparent from the description, the drawings, and the claims.

### BRIEF DESCRIPTION OF THE DRAWINGS

FIG. 1 is an example system for regulating exhaust in an engine.

FIG. 2 is a schematic of a system including a barometric pressure regulator circuit.

FIG. 3 is a flow chart of an example process for optimizing the performance of an engine.

FIG. 4 is a flow chart of an example process for optimizing the performance of an engine.

FIG. 5 is a flow chart of an example process for operating a pump in an exhaust system.

Like reference numbers and designations in the various drawings indicate like elements.

### DETAILED DESCRIPTION

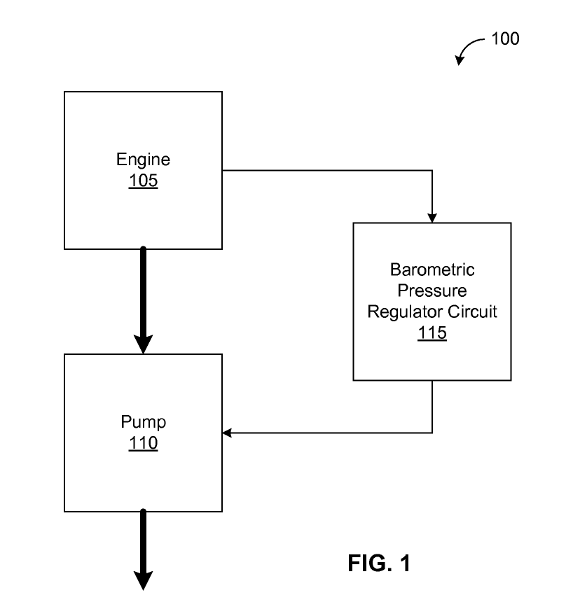

FIG. 1 is an example system 100 for regulating exhaust in an engine 105. In some implementations, the engine 105 can be an internal combustion engine. Alternatively, the engine 105 can be any automobile or industrial equipment that uses a combustible fuel to supply energy to a vehicle. The waste from the fuel is expelled as exhaust gases. The system 100 can include a pump 110 that is operatively coupled to the engine 105. In general, the pump 105 can be any pressure regulation device, e.g., a venturi meter, and the like, that can be used to control pressure in the engine 105. The system 100 can include a barometric pressure regulator circuit 115 that can be operatively coupled to the engine 105 and the pump 110. The barometric pressure regulator circuit 115 can receive operating parameters of the engine 105 as input and provide operating parameters to the pump 110 as output, as described below.

The pump 110 can be operatively coupled to the engine 105 to regulate the flow of exhaust gases from the engine 105, thereby controlling the pressure in the engine's exhaust system. For example, to regulate the air flow, the pump 110 can increase the volumetric flow rate through the exhaust system of the engine 105. This can reduce the air pressure inside of the exhaust system, thereby increasing airflow through the exhaust system and boosting engine performance. In some implementations, the pump 110 can be any fan or system of moving a gas inside of the exhaust system of the engine 105.

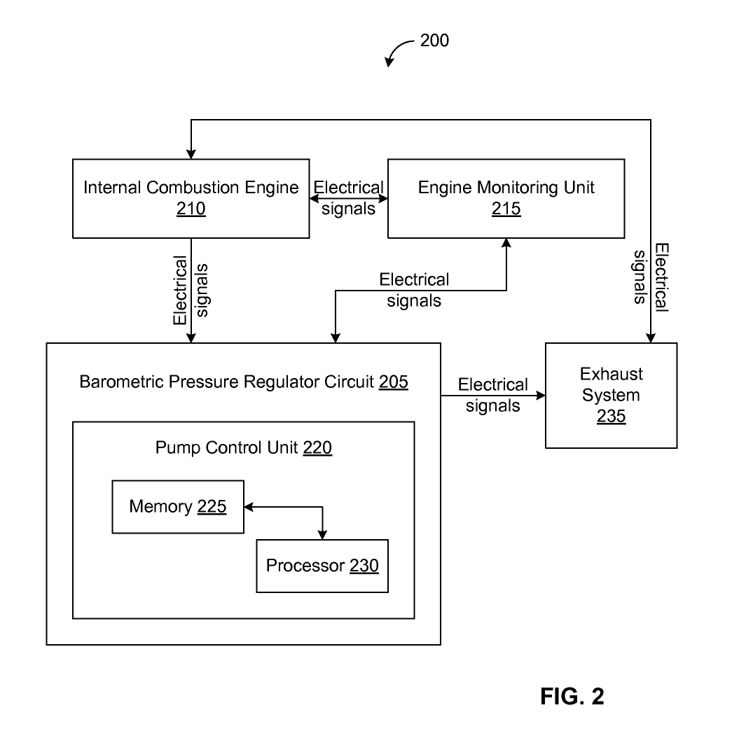

FIG. 2 is a schematic of a system 200 including a barometric pressure regulator circuit 205. The circuit 205 receives input from an internal combustion (IC) engine 210 and provides output to an exhaust system 235, that can include a pressure regulation system, e.g., a pump (not shown). In some implementations, the system 200 can include an engine monitoring unit 215 configured to monitor input parameters provided to the IC engine and output parameters provided by the IC engine 210. The input and output parameters of the IC engine 210 represent the engine activity, and can include engine boost, pressure in the turbo, oxygen sensor information, information about the richness and leanness of the fuel mixture, the air intake, back pressure in the exhaust system, and the like.

In some implementations, the engine monitoring unit 215 can include multiple sensors that are operatively coupled to the IC engine 210. For example, the sensors can be located at locations on or adjacent to the engine 210. The sensors can be, e.g., transducers configured to transducer output from the IC engine 210 into electrical signals. Such sensors can include piezoelectric pressure sensor, barometric pressure sensors, thermocouples, engine RPM sensors, and the like. For example, the sensors can transmit the electrical signals to the engine monitoring unit 215 as voltage signals ranging between 0 and 100 volts DC. In some implementations, the engine monitoring unit 215 can include storage facilities, e.g., a computer-readable medium on which the electrical signals from the sensors can be stored. For example, the computer-readable medium can store the electrical signals in a table. The table can include multiple rows and columns, where each row can include an identifier corresponding to a parameter, e.g., exhaust back pressure, and a value of an electrical signal received from the sensor configured to measure the parameter. In some scenarios, the electrical signals can be digital data that are stored as binary numbers.

In some implementations, the engine monitoring unit 215 can be operatively coupled to the circuit 205 and can transmit the collected parameters to the circuit 205. For example, the engine monitoring unit 215 can transmit the collected parameters through a signal line carrying the electrical signal. The signal line that transmits electrical signals between the connected components of the system 200 can be any type of signal carrying assembly which allows for the transmission of electrical signals in either one or both directions between the circuit and the engine monitoring unit 215. For example, the signal line can be a wiring harness having a number of signal lines, e.g., wires, which transmit electrical signals.

In some implementations, the circuit 205 can receive all the parameters collected by the engine monitoring unit 215. In some implementations, the circuit 205 can request and receive only those parameters that are related to the exhaust system 235 of the IC engine. Such parameters can include information related to oxygen sensors, turbo pressure, back pressure in the exhaust, and the like.

In some implementations, the circuit 205 can include a pump control unit 220 configured to receive the information from the engine monitoring unit 215. The pump control unit 220 can include a memory 225, e.g., a computer-readable memory, and a processor 230, e.g., an application specific integrated circuit (ASIC), configured to process the information stored in the memory 225. In general, the processor 230 can be any processor that can compute binary data.

The processor 230 can be configured to retrieve information stored in the memory 225 and determine optimal performance parameters of the exhaust system 235. As will be described later, the exhaust system 235 can include a pump, that can be accelerated or decelerated based on the optimal performance parameters determined by the processor 230. In some implementations, the processor 230 can select the optimal performance parameters from performance presets that include factory/OEM settings based on the IC engine 205, settings based on the vehicle, combinations of both, and the like.

In some implementations, performance presets can have been previously determined and stored in the memory 225. Such presets can be obtained, e.g., as a result of experiments conducted during the testing stages of the IC engine 210. In some implementations, the performance presets can be stored in the memory 225 as data maps. Such data maps can include multi-dimensional arrays including multiple two dimensional arrays. Each two dimensional array can represent an engine parameter in the performance presets with the values representing multiple pump parameter values corresponding to multiple engine parameters. For example, the data map can include a two dimensional array for engine back pressure. The two-dimensional array can include multiple values for speeds of a fan of a pump in the exhaust system 235 corresponding to multiple values for engine back pressures. In this manner, the data map stored in the memory 225 can include multiple IC engine 210 parameter values and corresponding exhaust system 235 parameter values.

In some implementations, the processor 230 can be configured to execute algorithms to dynamically determine parameters for optimal performance of the IC engine 210 based on the input parameters received from the engine monitoring unit 215. For example, mathematical formulas can be programmed into the processor 230 that can receive values representing the information gathered by the engine monitoring unit 215 as input. In response, the processor 215 can execute the algorithms to determine output values representing input parameters to a pump in the exhaust system 235. Operating the pump at the input parameters determined by the processor 215 can cause the exhaust system 235 to regulate air flow through the IC engine 215, thereby increasing the performance of the IC engine 210.

In some implementations, the processor 230 can be a machine-learning system configured to initially use the performance presets to determine input values for the pump in the exhaust system 235, and continuously monitor the response of the IC engine 210 to the values provided to the exhaust system 235. Based on the monitoring, the processor 230 can learn the input values that need to be provided to the exhaust system 235 to obtain optimal engine performance.

The circuit 205 can transmit the output values determined by the processor 230 to the exhaust system 235. The exhaust system 235 can receive the output values from the circuit 205 as input values to the pump included in the exhaust system 235. The pump in the exhaust system 235 is operatively coupled to the IC engine 210, e.g., to the exhaust manifold of the IC engine 210. The operation of the pump regulates the air flow in the exhaust manifold of the IC engine 210, thereby optimizing the performance of the IC engine 210.

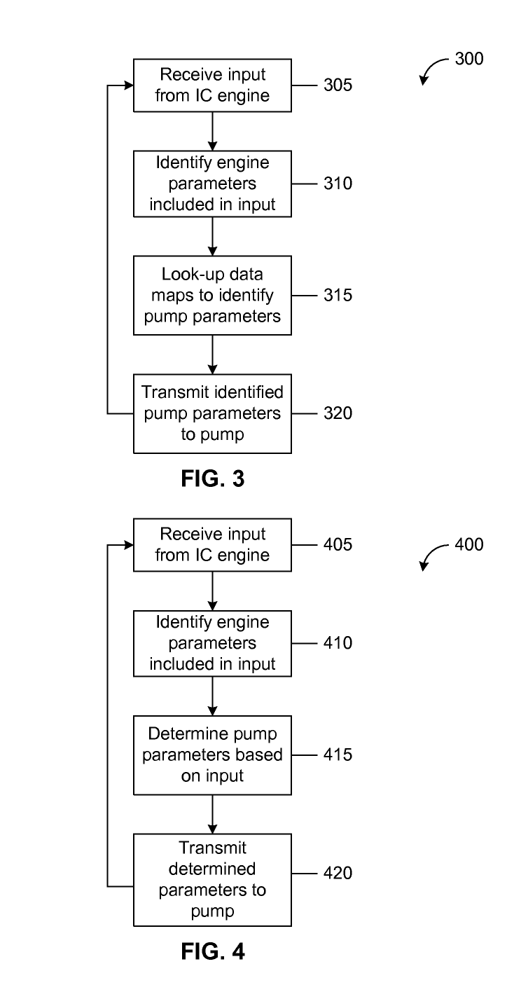

FIG. 3 is a flow chart of an example process 300 for optimizing the performance of an engine. In some implementations, the process 300 receives input from an IC engine (step 305). For example, the barometer pressure regulator circuit 205 receives input from the engine monitoring unit 215 operatively coupled to the IC engine 210.

The process 300 identifies engine parameters included in input (step 310). For example, the circuit 205 stores the received input in memory 225 and identifies, from the stored values, parameters that affect the performance of the engine. This can include all or some of the values stored in memory 225.

The process 300 looks-up data maps to identify pump parameters 315. For example, the processor 225 can look up data maps stored in memory 225 that include the performance presets. As described previously, the performance presets include parameters to operate the pump. The circuit 205 can identify the pump parameters from the data maps.

The process 300 transmits identified pump parameters to pump (step 320). For example, the circuit 205 can transmit the identified pump parameters to the exhaust system 235, that includes the pump, as electrical signals through one or more signal lines. In response, the exhaust system 235 operates the pump at parameters corresponding to the received input, thereby optimizing the engine performance.

FIG. 4 is a flow chart of an example process 400 for optimizing the performance of an engine. Similar to process 300, the process 400 receives input from the IC engine (step 405) and identifies engine parameters included in the input (step 410). The process 400 determines pump parameters based on input (step 415). To do so, the process 400 executes computer-executable algorithms that are implemented as a processor, e.g., processor 230. As described previously, the algorithms receive the engine parameters as input and provide pump parameters as output. Similar to the process 300, the process 400 transmits determined parameters to the pump (step 420).

In executing both processes 300 and 400, circuit 205 can monitor the performance of the IC engine, in response to the parameters transmitted to the pump. The monitored parameters can serve as input to the circuit 205 to re-compute pump parameters to optimize engine performance. In this manner, the circuit 205 can serve as a feedback mechanism.

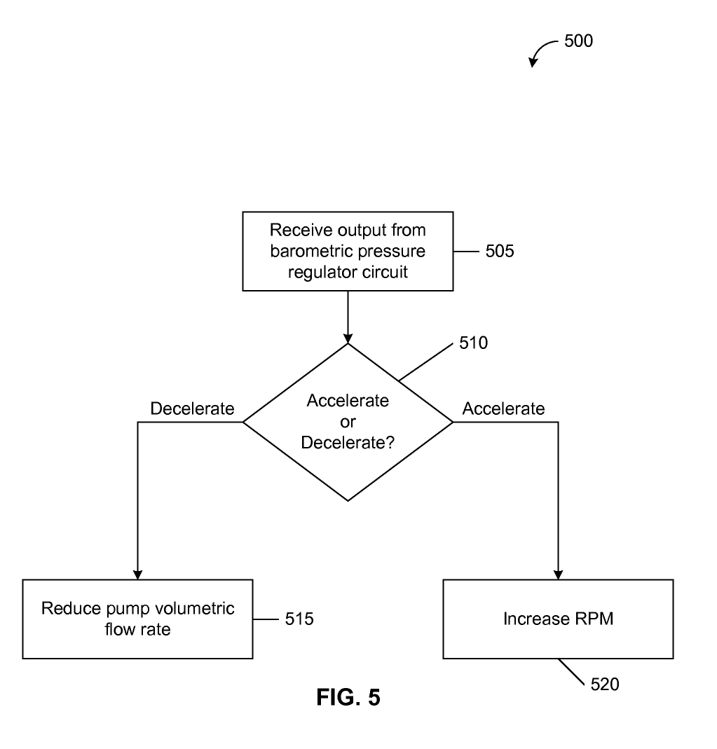

FIG. 5 is a flow chart of an example process 500 for operating a pump in an exhaust system. The process 500 can receive output from the barometric pressure regulator circuit (step 505). For example, the exhaust system 235, to which a pump is operatively coupled, can receive this output. The exhaust system 235 can include a microcontroller configured to determine output parameters to be supplied to the pump based on values received from the circuit 205.

The process 500 can check if the pump needs to be accelerated or decelerated (step 510). Based on the determined output parameters, the exhaust system 235 can accelerate or decelerate the pump. To decelerate the pump, the process 500 can reduce the pump volumetric flow rate (step 515). Alternatively, to accelerate the pump, the process can increase the RPM (step 520), e.g., of the pump fan.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

While this specification contains many specifics, these should not be construed as limitations on the scope of the specification or of what may be claimed, but rather as descriptions of features specific to particular implementations of the specification. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the specification have been described. Other implementations are within the scope of the following claims. For example, the actions recited in the claims can be performed in a different order and still achieve desirable results.

What is claimed is:

1. A system comprising:
an engine;
an engine monitoring unit operatively coupled to the engine, the engine monitoring unit configured to receive signals representing output parameters of the engine;
a pressure regulator circuit operatively coupled to the engine monitoring unit, the pressure regulator circuit configured to receive one or more of the signals representing the output parameters of the engine from the engine monitoring unit, the pressure regulator circuit further configured to determine output parameters to control a pressure in the engine; and
a pressure regulator unit operatively coupled to the pressure regulator circuit, the pressure regulator unit configured to receive the output parameters to control the pressure in the engine, the pressure regulator unit operatively coupled to the engine to control an engine pressure, wherein the pressure regulator unit controls the engine pressure based on the output parameters determined by the pressure regulator circuit.

2. The system of claim 1, wherein the engine is an internal combustion engine.

3. The system of claim 1, wherein the pressure regulator unit is a pump.

4. The system of claim 1, wherein the received signals representing output parameters of the engine are electrical signals.

5. The system of claim 4, further comprising one or more electrical wires connecting the engine and the engine monitoring unit, the one or more wires configured to transmit the electrical signals.

6. The system of claim 1, wherein one or more signals received by the pressure regulator circuit are electrical signals having corresponding voltages, the pressure regulator circuit further comprising a memory configured to store the voltages corresponding to the one or more signals.

7. The system of claim 6, wherein the memory is configured to store the voltages as binary numbers.

8. The system of claim 6, the pressure regulator circuit further comprising a processor configured to:
retrieve the one or more voltages from the memory;
determine values representing the output parameters to control the pressure in the engine; and
transmit the determined values to the pressure regulator unit as electrical signals.

9. The system of claim 1, further comprising a plurality of sensors operatively coupled to the engine to determine the output parameters of the engine.

10. The system of claim 9, wherein the plurality of sensors include a piezoelectric pressure sensor, a barometric pressure sensor, a thermocouple, and an RPM sensor.

11. A pressure regulator circuit comprising:
a memory storing output parameters to be supplied to a pressure regulator unit; and
a processor operatively coupled to the memory, the processor configured to perform operations comprising:
receiving voltage signals representing output parameters of an engine;
storing the received voltage signals in the memory;
identifying output parameters to be supplied to the pressure regulator unit that correspond to the received voltage signals;
converting the identified output parameters into output electrical signals; and
transmitting the output electrical signals to the pressure regulator unit.

12. The pressure regulator unit of claim 11, wherein the pressure regulator unit is a pump.

13. The pressure regulator unit of claim 11, wherein the engine is an internal combustion engine.

14. The pressure regulator unit of claim 11, wherein the processor receives the voltage signals through one or more electrical wires.

15. The pressure regulator unit of claim 11, wherein the processor transmits the output voltage signals to the pressure regulator unit through a wiring harness including a plurality of wires.

16. The pressure regulator of claim 11, the memory further storing preset parameters including the output parameters to be supplied to the pressure regulator unit and preset values corresponding to the output parameters.

17. The pressure regulator of claim 16, wherein the processor is further configured to identify the output parameters to be supplied to the pressure regulator unit by:
identifying the preset values that match values of the voltage signals that represent the output parameters of the engine; and
identifying the output parameters corresponding to the identified preset values.
